(19) United States
(12) Patent Application Publication
(10) Pub. No.: US 2016/0377938 A1
(43) Pub. Date: Dec. 29, 2016

(54) LIQUID CRYSTAL DISPLAY DEVICE HAVING UNIT SUB-PIXEL ELECTRODES

(71) Applicant: SAMSUNG DISPLAY CO., LTD., Yongin-si (KR)

(72) Inventors: KIPYO HONG, Hwaseong-si (KR); IKHAN OH, Cheonan-si (KR); YOUNHAK JEONG, Cheonan-si (KR); WAN NAMGUNG, Asan-si (KR); HOJUN LEE, Asan-si (KR); SEHYUN LEE, Seoul (KR)

(21) Appl. No.: 15/137,034

(22) Filed: Apr. 25, 2016

(30) Foreign Application Priority Data
Jun. 25, 2015 (KR) 10-2015-0090626

(51) Int. Cl. G02F 1/1343

(52) U.S. Cl. CPC G02F 1/134309; G02F 1/13439; G02F 2001/134345; G02F 2201/503

(57) ABSTRACT

A liquid crystal display device includes a curved first substrate and a curved second substrate. A liquid crystal layer is between the first curved substrate and the second curved substrate. A pixel electrode is on the first substrate. The pixel electrode includes a plurality of unit sub-pixel electrodes. A common electrode is on the second substrate. The common electrode has a planar shape. A connecting portion connects at least two of the plurality of unit sub-pixel electrodes to each other. A protrusion is disposed on the connecting portion.

### CROSS-REFERENCE TO RELATED APPLICATION

This application claims priority under 35 U.S.C. §119 to Korean Patent Application No. 10-2015-0090626, filed on Jun. 25, 2015, in the Korean Intellectual Property Office, the disclosure of which is incorporated by reference herein in its entirety.

### TECHNICAL FIELD

Exemplary embodiments of the present invention relate to a liquid crystal display (“LCD”) device, and more particularly, to an LCD device having unit-subpixel electrodes.

### DISCUSSION OF RELATED ART

An LCD device may be a flat panel display (“FPD”) device. An LCD device may include two substrates including electrodes formed thereon and a liquid crystal layer disposed between the two substrates. In an LCD device, liquid crystal molecules of the liquid crystal layer may be rearranged by voltages that are applied to the two electrodes, thus adjusting the amount of transmitted light and displaying an image on the LCD device.

A display device may include an upper electrode and a lower electrode having patterns respectively formed thereon to control liquid crystals. In a curved display device defects caused by a misalignment between the upper electrode and the lower electrode may occur.

A curved display device may include the upper electrode without patterns and may control liquid crystals using only the lower electrode.

When the liquid crystals are controlled using only the lower electrode, the liquid crystals may be misaligned due to physical impacts or vibrations, and the liquid crystals may be less likely to return to an original state.

### SUMMARY

Exemplary embodiments of the present invention may be directed to a liquid crystal display (“LCD”) device that may be provided as a curved display device and may reduce or prevent defects caused by physical impacts or vibrations.

According to an exemplary embodiment of the present invention, a liquid crystal display device includes a curved first substrate and a curved second substrate. A liquid crystal layer is between the first curved substrate and the second curved substrate. A pixel electrode is on the first substrate. The pixel electrode includes a plurality of unit sub-pixel electrodes. A common electrode is on the second substrate. The common electrode has a planar shape. A connecting portion connects at least two of the plurality of unit sub-pixel electrodes to each other. A protrusion is disposed on the connecting portion.

The protrusion may have a height in a range of from about 0.5 μm to about 2.0 μm.

The protrusion may surround an edge of at least two of the plurality of unit sub-pixel electrodes.

The plurality of unit sub-pixel electrodes may include a cross-shaped stem portion, and branch portions extending from the cross-shaped stem portion in upper-right, lower-right, upper-left, and lower-left directions, respectively.

The connecting portion may extend from the cross-shaped stem portion.

The connecting portion may extend from the branch portions.

The protrusion may have a cross shape.

Each of the plurality of unit sub-pixel electrodes may include a planar portion having a diamond shape, and branch portions extending from the planar portion in upper-right, lower-right, upper-left, and lower-left directions, respectively.

The connecting portion may extend from the planar portion.

The connecting portion may extend from at least one of the branch portions.

The protrusion may have a cross shape.

### BRIEF DESCRIPTION OF THE DRAWINGS

A more complete appreciation of the present invention will become more apparent by describing in detail exemplary embodiments thereof with reference to the accompanying drawings, in which:

FIG. 1 is a schematic perspective view illustrating a liquid crystal display (“LCD”) device according to an exemplary embodiment of the present invention;

FIG. 2 is a plan view illustrating a pixel of an LCD device according to an exemplary embodiment of the present invention;

FIG. 3 is a cross-sectional view taken along section line I-I′ of FIG. 2;

FIG. 4 is a cross-sectional view taken along section line II-II′ of FIG. 2; and

FIGS. 5, 6, 7, 8, and 9 are plan views illustrating pixel electrodes and protrusions according to exemplary embodiments of the present invention.

### DETAILED DESCRIPTION

Exemplary embodiments of the present invention will now be described in more detail with reference to the accompanying drawings.

Exemplary embodiments of the present invention can be modified in various manners and are not limited to the exemplary embodiments described herein.

Throughout the specification and drawings, when an element is referred to as being “connected” to another element, the element may be “directly connected” to the other element, or “electrically connected” to the other element, and one or more intervening elements may be disposed between the elements.

It will be understood that, although the terms “first,” “second” and “third” may be used herein to describe various elements, these elements should not be limited by these terms.

Like reference numerals may refer to like elements throughout the specification and drawings.

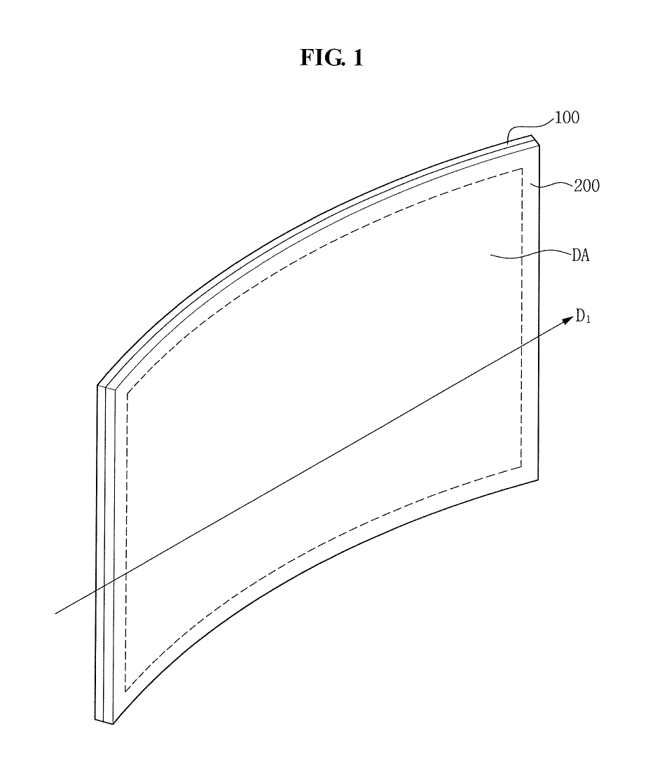

FIG. 1 is a schematic perspective view illustrating a liquid crystal display (“LCD”) device according to an exemplary embodiment of the present invention.

Referring to FIG. 1, a LCD device may include a first display panel 100 and a second display panel 200. The first display panel 100 may face the second display panel 200. A liquid crystal layer may be disposed between the first display panel 100 and the second display panel 200. The first display panel 100 and the second display panel 200 may be curved with respect to at least one direction, for example, a first direction D1. Thus, a display area DA may have a curved shape that is curved with respect to the first direction D1.

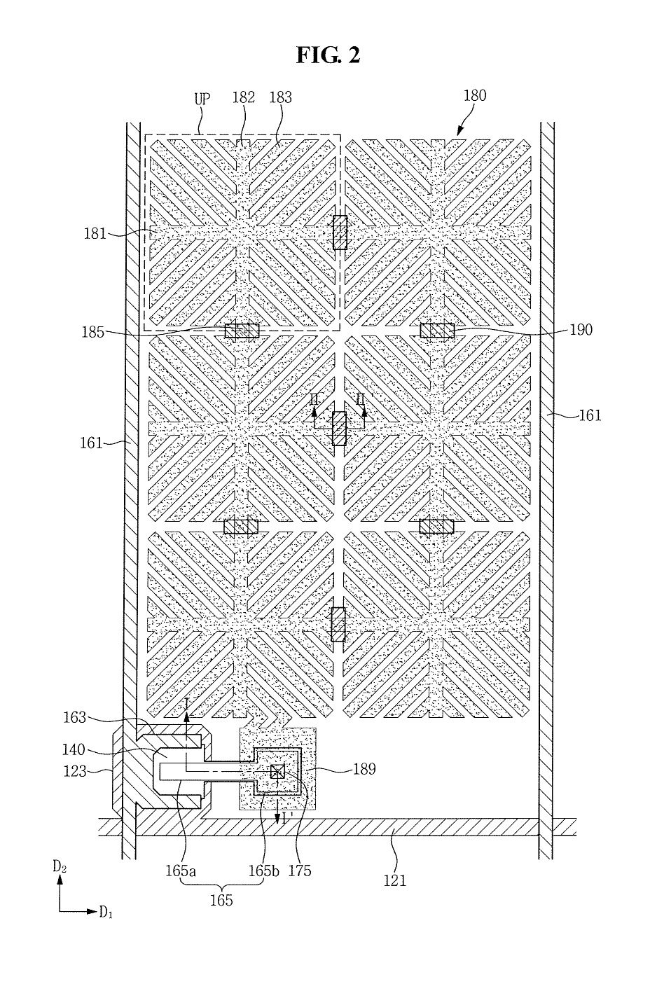

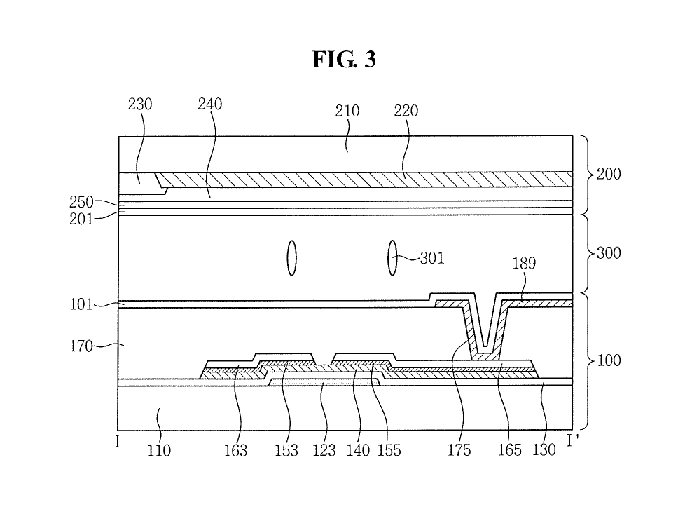

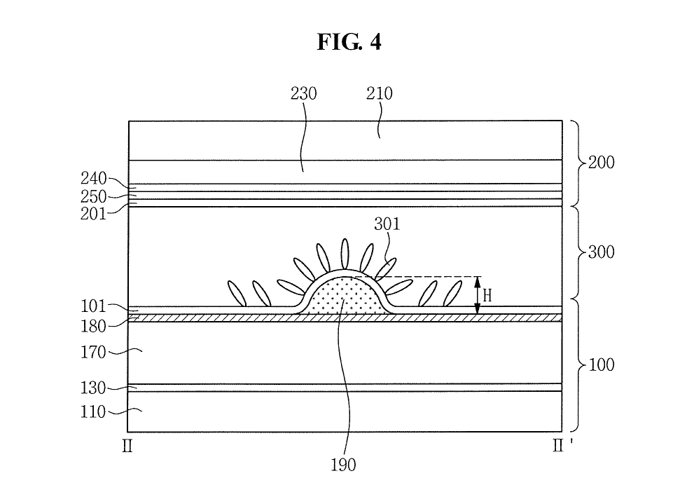

FIG. 2 is a plan view illustrating a pixel of an LCD device according to an exemplary embodiment of the present invention. FIG. 3 is a cross-sectional view taken along section line I-I′ of FIG. 2. FIG. 4 is a cross-sectional view taken along section line II-II′ of FIG. 2.

Referring to FIGS. 2, 3, and 4, the LCD device may include the first display panel 100 and the second display panel 200, and a liquid crystal layer 300 disposed between the first display panel 100 and the second display panel 200.

The liquid crystal layer 300 may be disposed in a sealant between the first display panel 100 and the second display panel 200. The liquid crystal layer 300 may be a dielectric body. The sealant may be disposed on at least one of the first display panel 100 and the second display panel 200. The sealant may couple the first display panel 100 to the second display panel 200.

The first display panel 100 and the second display panel 200 may maintain a cell distance (e.g., a cell gap) between the first display panel 100 and the second display panel 200 in a range of from about 2.0 micrometers (μm) to about 5.0 μm. The cell gap may be maintained by the sealant or by a spacer. For example, the cell gap may be maintained in a range of from about 3.3 μm to about 3.7 μm.

Polarizers may be disposed on the first display panel 100 and the second display panel 200, respectively, and respective polarizing axes or respective transmittance axes of the polarizers may be substantially perpendicular to the first display panel 100 and the second display panel 200. The polarizers may be disposed on or below the first display panel 100 and on or below the second display panel 200, respectively.

The first display panel 100 will be described in more detail below.

The LCD device may include a first substrate 110. The first substrate 110 may be an insulating substrate. The first substrate 110 may include plastic or transparent glass such as soda lime glass or borosilicate glass.

Gate wirings 121 and 123, which may transmit a gate signal, may be disposed on the first substrate 110.

The gate wirings 121 and 123 may include an aluminum (Al) based metal such as Al or an Al alloy, a silver (Ag) based metal such as Ag or an Ag alloy, a copper (Cu) based metal such as Cu or an Cu alloy, a molybdenum (Mo) based metal such as Mo or a Mo alloy, chromium (Cr), titanium (Ti), and tantalum (Ta).

The gate wirings 121 and 123 may have a multilayer structure including at least two conductive layers having different physical properties from one another. For example, in the multilayer structure, one of the two conductive layers may include a metal having relatively low resistivity, for example, an Al-based metal, an Ag-based metal or a Cu-based metal, which may reduce or eliminate a signal delay or a voltage drop. The other of the two conductive layers may include a material, for example, a Mo-based metal, Cr, Ti or Ta, which may have a relatively high contact property with respect to indium-tin oxide (“ITO”) and indium-zinc oxide (“IZO”).

Combinations of layers in the multilayer structure according to exemplary embodiments of the present invention may include a structure including a Cr lower layer and an Al upper layer, a structure including an Al lower layer and a Mo upper layer, and a structure including a Ti lower layer and a Cu upper layer. However, exemplary embodiments of the present invention are not limited thereto, and the gate wirings 121 and 123 may include various other metals and conductive materials.

The gate wirings 121 and 123 may include a gate line 121 extending in a direction, for example, the first direction D1, and a gate electrode 123 protruding from the gate line 121. The gate electrode 123 may extend in a second direction D2, which may be perpendicular to the first direction D1.

The gate electrode 123, a source electrode 163 and a drain electrode 165, which are described in more detail below, may be three terminals of a thin film transistor.

A gate insulating layer 130 may be disposed on the first substrate 110 on which the gate wirings 121 and 123 may be formed. The gate insulating layer 130 may include silicon oxide (SiO_{X}) or silicon nitride (SiN_{X}). The gate insulating layer 130 may include aluminum oxide, titanium oxide, tantalum oxide, or zirconium oxide.

A semiconductor layer 140 may be disposed on the gate insulating layer 130. The semiconductor layer 140 may substantially overlap data wirings 161, 163, and 165, which are described in more detail below. However, the semiconductor layer 140 according to exemplary embodiments of the present invention is not limited thereto, and the semiconductor layer 140 may only be disposed on a portion of the gate insulating layer 130 that corresponds to the gate electrode 123.

The semiconductor layer 140 may include an oxide semiconductor including one or more of amorphous silicon (a-Si), polycrystalline silicon (poly-Si), gallium (Ga), indium (In), tin (Sn), and zinc (Zn).

Ohmic contact layers 153 and 155 may be disposed on the semiconductor layer 140. The ohmic contact layers 153 and 155 may increase a contact property between the semiconductor layer 140, and the source electrode 163 and/or the drain electrode 165. The ohmic contact layers 153 and 155 may be absent in a channel region between the source electrode 163 and the drain electrode 165.

According to an exemplary embodiment of the present invention, the ohmic contact layers 153 and 155 may include amorphous silicon doped with n-type impurities (n+ a-Si) at relatively high-concentration. The ohmic contact layers 153 and 155 may be omitted. For example, the ohmic contact layers 153 and 155 may be omitted when a contact property between the semiconductor layer 140, and the source electrode 163 and/or the drain electrode 165 is relatively high.

The data wirings 161, 163, and 165 may be disposed on the semiconductor layer 140. The data wirings 161, 163, and 165 may include a same material as a material included in the gate wirings 121 and 123.

The data wirings 161, 163, and 165 may include a data line 161, the source electrode 163, and the drain electrode 165. The data line 161 may be formed in a direction intersecting the gate line 121, for example, the second direction D2.

The source electrode 163 may extend from the data line 161 and may be in contact with the gate electrode 123. The drain electrode 165 may include a first end portion 165a. The first end portion 165a may face the source electrode 163 and may have a rectangular shape. The drain electrode 165 may include a second end portion 165b. The second end portion 165b may have a relatively wide planar area with respect to the gate electrode 123.

A channel through which a charge may be transmitted during the operation of the thin film transistor may be formed in the semiconductor layer 140 between the source electrode 163 and the drain electrode 165.

When the semiconductor layer 140 and the data wirings 161, 163, and 165 are formed using the same mask, the data wirings 161, 163, and 165 may have substantially the same pattern, except for the channel region, as a pattern of the semiconductor layer 140 which may be formed below the data wirings 161, 163, and 165.

A passivation layer 170 may be formed on the data wirings 161, 163, and 165. The passivation layer 170 may have a monolayer or multilayer structure including, for example, silicon oxide (SiO_{X}), silicon nitride (SiN_{X}), a photosensitive organic material, or a low-dielectric-constant insulating material such as a-Si:C:O or a-Si:O:F.

A pixel electrode 180 may be disposed on a pixel region of the passivation layer 170. The pixel region may be an area defined by a light blocking member 220. The light blocking member 220 is described in more detail below. The pixel electrode 180 may include a transparent conductive material such as indium-tin oxide (“ITO”) or indium-zinc oxide (“IZO”).

A contact hole 175 may be formed in the passivation layer 170, and a portion of the drain electrode 165 may be exposed through the contact hole 175. The pixel electrode 180 may receive a data voltage from the drain electrode 165 through the contact hole 175.

The pixel electrode 180 may include a plurality of unit sub-pixel electrodes UP. The plurality of unit sub-pixel electrodes UP may be arranged in a matrix form in the pixel region. While FIG. 2 illustrates the plurality of unit sub-pixel electrodes UP as being arranged in a 3×2 matrix form, the arrangement of the plurality of unit sub-pixel electrodes UP according to exemplary embodiments of the present invention is not limited thereto. The plurality of unit sub-pixel electrodes UP may be arranged in various shapes, for example, based on a size of the pixel region, or based on a force of controlling liquid crystals.

Each of the plurality of unit sub-pixel electrodes UP may include cross-shaped stem portions 181 and 182, branch portions 183 extending from the cross-shaped stem portions 181 and 182 in upper-right, lower-right, upper-left, and lower-left directions, respectively, a connecting portion 185 extending from the cross-shaped stem portions 181 and 182, and a connector 189 extending from the branch portion 183.

The cross-shaped stem portions 181 and 182, the branch portion 183, and the connecting portion 185 may have a width in a range of from about 4 μm to about 6 μm. However, the thicknesses of the cross-shaped stem portions 181 and 182, the branch portion 183, and the connecting portion 185 according to exemplary embodiments of the present invention are not limited thereto.

The cross-shaped stem portions 181 and 182 may include a transverse stem portion 181 extending in parallel to the gate line 121, and a longitudinal stem portion 182 extending in a direction parallel to the data line 161.

An acute angle between the branch portion 183 and the transverse stem portion 181 may be in a range of from about 40 degrees to about 45 degrees. However, the angle between the branch portion 183 and the transverse stem portion 181 according to exemplary embodiments of the present invention is not limited thereto, and the angle may be adjusted based, for example on the visibility of the LCD device.

The connecting portion 185 may apply a data signal to adjacent ones of the unit sub-pixel electrodes UP. The connecting portion 185 may connect cross-shaped stem portions 181 and 182 of the adjacent ones of the unit sub-pixel electrodes UP. For example, the connecting portion 185 may connect adjacent ones of the transverse stem portions 181 to one another, and adjacent ones of the longitudinal stem portions 182 to one another.

The connecting portion 185 may have a rectilinear shape extending in a same direction in which the transverse stem portion 181 or the longitudinal stem portion 182 extends.

A protrusion 190 may be disposed on the connecting portion 185. The protrusion 190 may have a same shape as that of the connecting portion 185. The protrusion 190 may include a transparent or opaque organic material. The protrusion 190 may have a height in a range of from about 0.5 μm to about 2.0 μm.

Liquid crystal molecules on the cross-shaped stem portions 181 and 182 and the branch portion 183 may receive a force that pushes the liquid crystal molecules into the unit sub-pixel electrode UP due to a fringe field generated between a common electrode 250, which is described below in more detail, and the cross-shaped stem portions 181 and 182 and the branch portion 183, and the liquid crystal molecules may be restored to an original state even when the orientation thereof is misaligned by external impacts.

However, liquid crystal molecules 301 on the connecting portion 185 may be less likely to be restored to an original state once the orientation of the liquid crystal molecules 301 is misaligned by external impacts because a fringe field might not be generated between the connecting portion 185 and the common electrode 250.

The LCD device according to an exemplary embodiment of the present invention may include the protrusion 190 disposed on the connecting portion 185, thus providing a pretilt to the liquid crystal molecules 301 on the connecting portion 185. As a physical force is additionally applied to the liquid crystal molecules 301 on the connecting portion 185, the liquid crystal molecules 301 may be restored to an original state even when the orientation thereof is misaligned by external impacts.

The connector 189 may receive a data voltage applied from the drain electrode 165 via the contact hole 175 through which a portion of the drain electrode 165 is exposed.

The second display panel 200 will be described in more detail below.

The LCD device may include a second substrate 210. The second substrate 210 may be an insulating substrate. The second substrate 210 may include a transparent material such as plastic, or glass such as soda lime glass or borosilicate glass.

The light blocking member 220 and a color filter 230 may be disposed on the second substrate 210.

The light blocking member 220 may define an aperture region through which light is transmitted. The light blocking member 220 may also be referred to as a black matrix, and may define the pixel region. The light blocking member 220 may include a metal such as chromium oxide (CrO_{X}) or an opaque organic layer forming material.

The color filter 230 may be disposed in an area surrounded by the light blocking member 220, and may have one of the following colors: red, green, blue, cyan, magenta, yellow, and white. Three primary colors such as, for example, red, green and blue, or cyan, magenta and yellow, may form a basic pixel group for displaying a color.

An overcoat layer 240 may be disposed on the light blocking member 220 and the color filter 230. The overcoat layer 240 may planarize a curved surface of layers below the overcoat layer 240, such as the light blocking member 220 and the color filter 230, or may reduce or prevent the penetration of impure elements from layers below the overcoat layer 240.

The common electrode 250 may be disposed on the overcoat layer 240. The common electrode 250 may be disposed over substantially an entire surface of the second substrate 210. The common electrode 250 may be a pattern-less whole plate without an additional pattern formed on the common electrode 250. The common electrode 250 may include a transparent conductive material, such as indium-tin oxide (“ITO”) or indium-zinc oxide (“IZO”).

In the LCD device according to an exemplary embodiment of the present invention, since an additional pattern is absent on the common electrode 250 on the second display plate 200, even in a case of providing a curved display device, a misalignment between the first display panel 100 and the second display panel 200 need not occur.

Alignment layers 101 and 201 may be disposed on inner surfaces of the first display panel 100 and the second display panel 200, respectively. The alignment layers 101 and 201 may be homeotropic alignment layers, or a photo-aligned alignment layers including a photopolymerization material. The photopolymerization material may be a reactive-monomer or a reactive mesogen.

The orientation of the alignment layers 101 and 201 may be parallel with respect to a direction of a normal line of the first substrate 110 and the second substrate 210. Thus, the liquid crystal molecules 301 of the liquid crystal layer 300 may have a major axis that is initially aligned in the direction of the normal line of the first substrate 110 and the second substrate 210 in a state in which an electric field is absent.

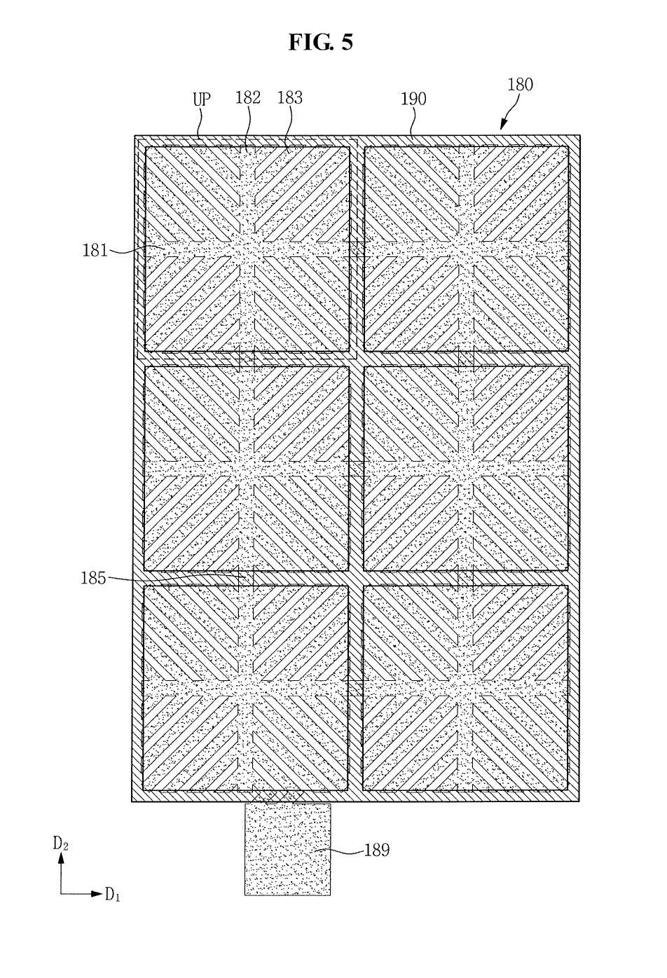

FIGS. 5, 6, 7, 8, and 9 are plan views illustrating pixel electrodes and protrusions according to exemplary embodiments of the present invention. The pixel electrodes and the protrusions may be substantially the same as the pixel electrodes and the protrusions according to the exemplary embodiments of the present invention described above and duplicative descriptions may be omitted.

Referring to FIG. 5, the pixel electrode 180 may include the plurality of unit sub-pixel electrodes UP. Each of the unit sub-pixel electrodes UP may include cross-shaped stem portions 181 and 182, branch portions 183 extending from the cross-shaped stem portions 181 and 182 in upper-right, lower-right, upper-left, and lower-left directions, respectively, the connecting portion 185 extending from the cross-shaped stem portions 181 and 182, and the connector 189 extending from the branch portion 183.

The connecting portion 185 may connect cross-shaped stem portions 181 and 182 of adjacent ones of the unit sub-pixel electrodes UP. For example, the connecting portion 185 may connect adjacent ones of transverse stem portions 181 to one another, and adjacent ones of longitudinal stem portions 182 to one another. The connecting portion 185 may have a rectilinear shape extending in a same direction as a direction in which the transverse stem portion 181 or the longitudinal stem portion 182 extends.

The protrusion 190 may be disposed along an edge of the unit sub-pixel electrode UP. In an exemplary embodiment of the present invention, the protrusion 190 may be disposed in a space between adjacent ones of the unit sub-pixel electrodes UP, or may overlap at least a portion of the branch portion 183. The protrusion 190 may be disposed on the connecting portion 185.

An LCD device according to another exemplary embodiment of the present invention may include the protrusion 190 disposed in an area in which the unit sub-pixel electrode UP is absent, thus providing a pretilt to liquid crystal molecules in the area in which the unit sub-pixel electrode UP is absent. Thus, even when the orientation of the liquid crystal molecules is misaligned by external impacts as a physical force is applied to the liquid crystal molecules, the liquid crystal molecules may be restored to an original state.

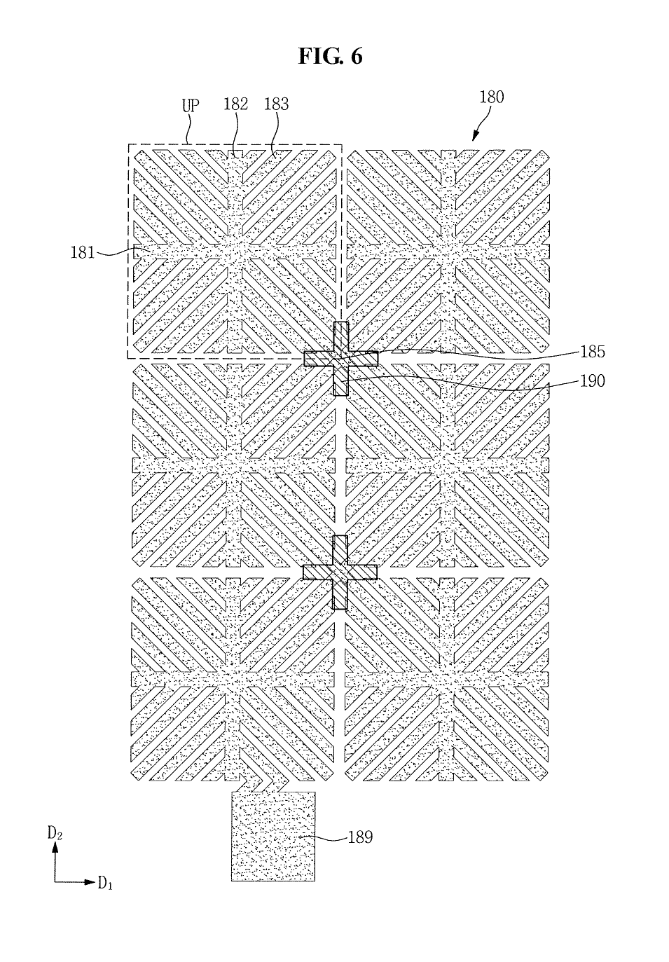

Referring to FIG. 6, the pixel electrode 180 may include the plurality of unit sub-pixel electrodes UP. Each of the unit sub-pixel electrodes UP may include cross-shaped stem portions 181 and 182, branch portions 183 extending from the cross-shaped stem portions 181 and 182 in upper-right, lower-right, upper-left, and lower-left directions, respectively, the connecting portion 185 extending from the branch portion 183, and the connector 189 extending from the branch portion 183.

The connecting portion 185 may connect branch portions 183 of adjacent ones of the unit sub-pixel electrodes UP.

For example, the branch portion 183 extending in the lower-right direction of one of the unit sub-pixel electrodes UP may be connected to a branch portion 183 extending in the upper-left of another of the unit sub-pixel electrodes UP that is in the lower-right direction with respect to the one unit sub-pixel electrode UP.

The connecting portion 185 may have a rectilinear shape extending in a same direction as a direction in which the branch portion 183 extends.

A protrusion 190 may be disposed on the connecting portion 185. The protrusion 190 may have a cross shape along edges of adjacent ones of the unit sub-pixel electrodes UP.

An LCD device according to another exemplary embodiment of the present invention may include the protrusion 190 disposed on the connecting portion 185, thus providing a pretilt to liquid crystal molecules on the connecting portion 185. Thus, even when the orientation of the liquid crystal molecules is misaligned by external impacts as a physical force is applied to the liquid crystal molecules, the liquid crystal molecules may be restored to an original state.

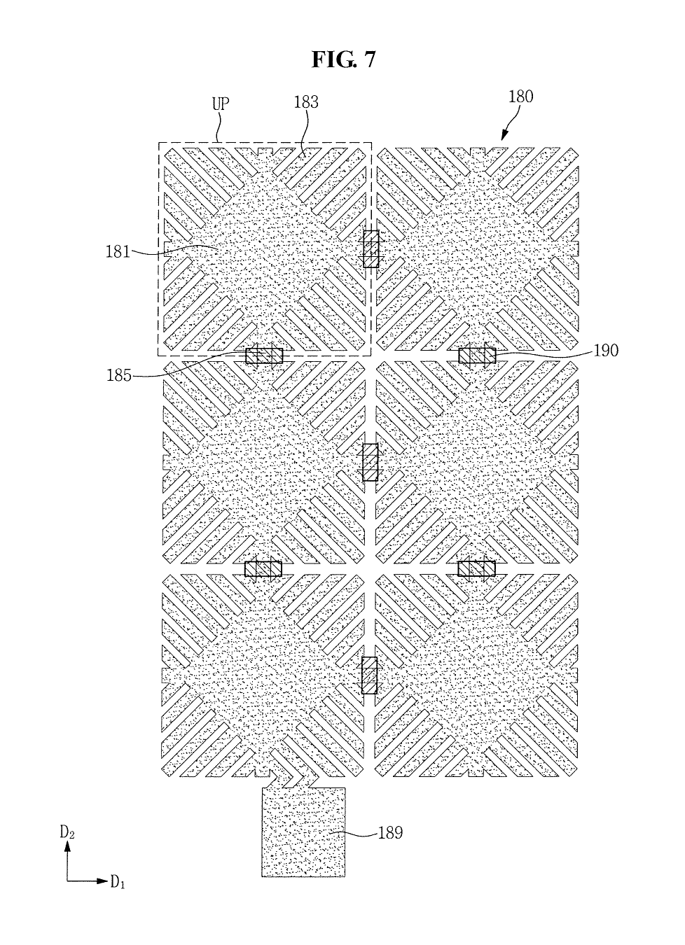

Referring to FIG. 7, the pixel electrode 180 may include the plurality of unit sub-pixel electrodes UP. Each of the unit sub-pixel electrodes UP may include a diamond-shaped planar portion 181, branch portions 183 extending from the diamond-shaped planar portion 181 in upper-right, lower-right, upper-left, and lower-left directions, respectively, the connecting portion 185 extending from the planar portion 181, and the connector 189 extending from the branch portion 183. The connecting portion 185 may connect respective planar portions 181 of adjacent ones of the unit sub-pixel electrodes UP.

The protrusion 190 may be disposed on the connecting portion 185, which may connect the planar portions 181. The protrusion 190 may have the same shape as that of the connecting portion 185.

An LCD device according to another exemplary embodiment of the present invention may include the protrusion 190 disposed on the connecting portion 185, thus providing a pretilt to liquid crystal molecules on the connecting portion 185. Thus, even when the orientation of the liquid crystal molecules is misaligned by external impacts as a physical force is applied to the liquid crystal molecules, the liquid crystal molecules may be restored to an original state.

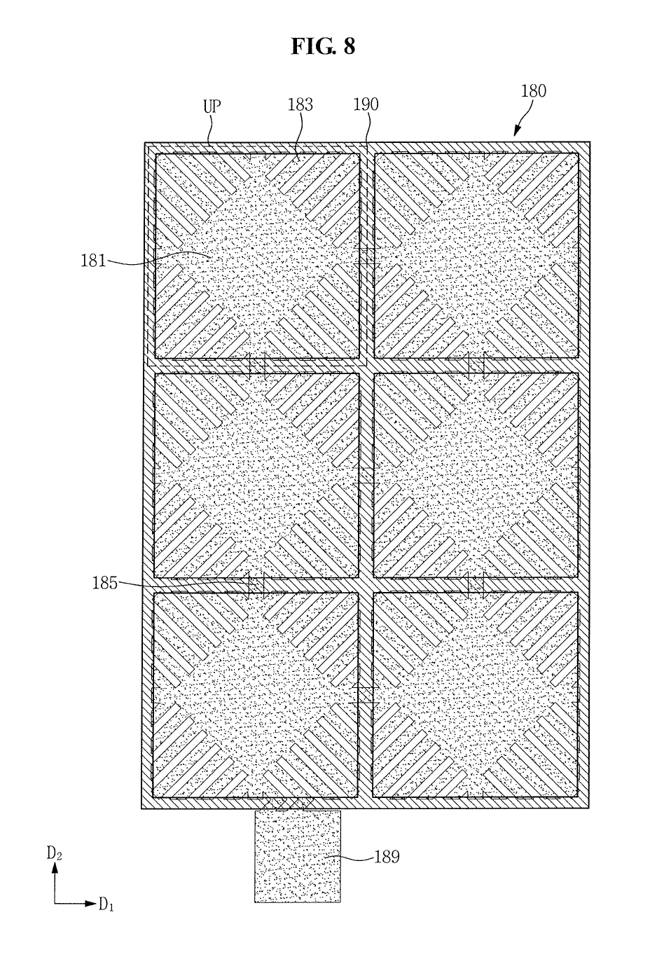

Referring to FIG. 8, the pixel electrode 180 may include the plurality of unit sub-pixel electrodes UP. Each of the unit sub-pixel electrodes UP may include the diamond-shaped planar portion 181, branch portions 183 extending from the diamond-shaped planar portion 181 in upper-right, lower-right, upper-left, and lower-left directions, respectively, the connecting portion 185 extending from the planar portion 181, and the connector 189 extending from the branch portion 183. The connecting portion 185 may connect respective planar portions 181 of adjacent ones of the unit sub-pixel electrodes UP.

The protrusion 190 may be disposed along an edge of the unit sub-pixel electrode UP. In an exemplary embodiment of the present invention, the protrusion 190 may be disposed in a space between adjacent ones of the unit sub-pixel electrodes UP, or may overlap at least a portion of the branch electrode 183. The protrusion 190 may be disposed on the connecting portion 185.

An LCD device according to another exemplary embodiment of the present invention may include the protrusion 190 in a space in which the unit sub-pixel electrode UP is absent, thus providing a pretilt to liquid crystal molecules in the space in which the unit sub-pixel electrode UP is absent. Thus, even when the orientation of the liquid crystal molecules is misaligned by external impacts as a physical force is applied to the liquid crystal molecules, the liquid crystal molecules may be restored to an original state.

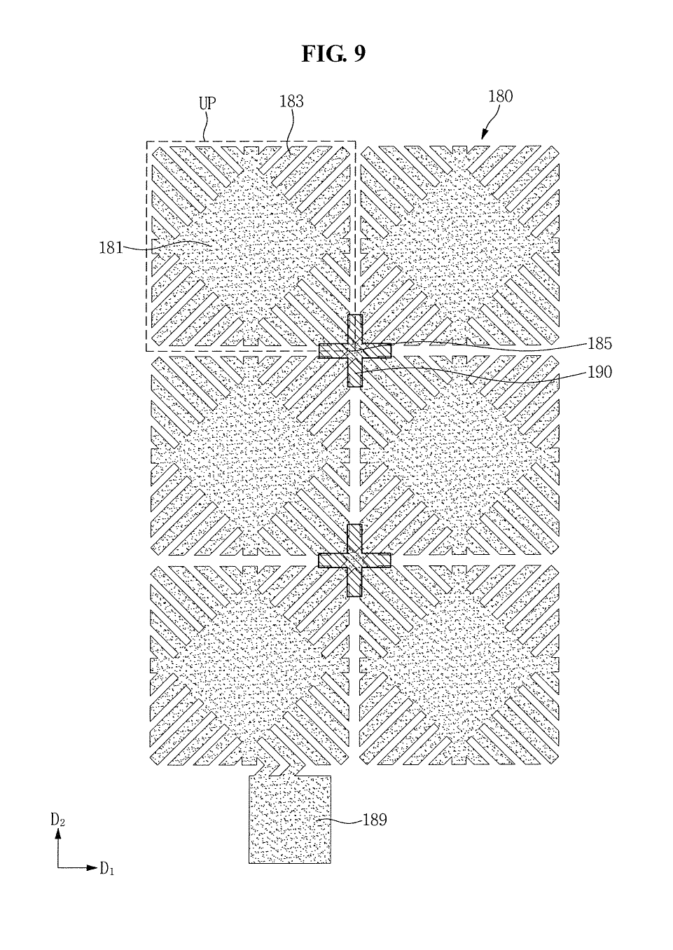

Referring to FIG. 9, the pixel electrode 180 may include the plurality of unit sub-pixel electrodes UP. Each of the unit sub-pixel electrodes UP may include the diamond-shaped planar portion 181, branch portions 183 extending from the diamond-shaped planar portion 181 in upper-right, lower-right, upper-left, and lower-left directions, respectively, the connecting portion 185 extending from the planar portion 181, and the connector 189 extending from the branch portion 183. The connecting portion 185 may connect respective planar portions 181 of adjacent ones of the unit sub-pixel electrodes UP.

The connecting portion 185 may connect respective branch portions 183 of adjacent ones of the unit sub-pixel electrodes UP.

For example, the branch portion 183 extending in the lower-right direction of one of the unit sub-pixel electrodes UP may be connected to the branch portion 183 extending in the upper-left of another of the unit sub-pixel electrodes UP and to the branch portion 183 extending in the lower-right direction one of another of the unit sub-pixel electrodes UP.

The connecting portion 185 may have a rectilinear shape extending in a same direction as a direction in which the branch portion 183 extends.

The protrusion 190 may be disposed on the connecting portion 185. The protrusion 190 may have a cross shape along edges of adjacent ones of the unit sub-pixel electrodes UP.

An LCD device according to another exemplary embodiment of the present invention may include the protrusion 190 disposed on the connecting portion 185, thus providing a pretilt to liquid crystal molecules on the connecting portion 185. Thus, even when the orientation of the liquid crystal molecules is misaligned by external impacts as a physical force is applied to the liquid crystal molecules, the liquid crystal molecules may be restored to an original state.

According to one or more exemplary embodiments of the present invention, an LCD device may be provided as a curved display device.

An LCD device according to one or more exemplary embodiments of the present invention may reduce or prevent defects resulting from external impacts or vibrations by providing a physical pretilt by forming the protrusion on the connecting portion that connects the unit sub-pixel electrodes.

While the present invention has been shown and described with reference to the exemplary embodiments thereof, it will be apparent to those of ordinary skill in the art that various changes in form and detail may be made thereto without departing from the spirit and scope of the present invention.

What is claimed is:

1. A liquid crystal display device comprising:
a curved first substrate and a curved second substrate;
a liquid crystal layer between the curved first substrate and the curved second substrate;
a pixel electrode on the curved first substrate, the pixel electrode comprising a plurality of unit sub-pixel electrodes;
a common electrode on the second substrate, the common electrode having a planar shape;
a connecting portion connecting at least two of the plurality of unit sub-pixel electrodes to each other; and
a protrusion disposed on the connecting portion.

2. The liquid crystal display device of claim 1, wherein the protrusion has a height in a range of from about 0.5 μm to about 2.0 μm.

3. The liquid crystal display device of claim 1, wherein the protrusion surrounds edges of at least two of the plurality of unit sub-pixel electrodes.

4. The curved liquid crystal display device of claim 1, wherein the plurality of unit sub-pixel electrode comprises a cross-shaped stem portion, and branch portions extending from the cross-shaped stem portion in upper-right, lower-right, upper-left, and lower-left directions, respectively.

5. The liquid crystal display device of claim 4, wherein the connecting portion extends from the cross-shaped stem portion.

6. The liquid crystal display device of claim 4, wherein the connecting portion extends from at least one of the branch portions.

7. The liquid crystal display device of claim 6, wherein the protrusion has a cross shape.

8. The liquid crystal display device of claim 1, wherein each of the plurality of unit sub-pixel electrodes comprises a planar portion having a diamond shape, and branch portions extending from the planar portion in upper-right, lower-right, upper-left, and lower-left directions, respectively.

9. The liquid crystal display device of claim 8, wherein the connecting portion extends from the planar portion.

10. The liquid crystal display device of claim 8, wherein the connecting portion extends from at least one of the branch portions.

11. The liquid crystal display device of claim 10, wherein the protrusion has a cross shape.

12. A liquid crystal display device comprising:
a curved first substrate and a curved second substrate;
a liquid crystal layer disposed between the curved first substrate and the curved second substrate;
a pixel electrode disposed on the curved first substrate, wherein the pixel electrode comprises a plurality of unit sub-pixel electrodes;
a connecting portion connecting at least two of the plurality of unit sub-pixel electrodes to each other, wherein the connecting portion includes a protrusion.

13. The liquid crystal display device of claim 12, wherein the protrusion has a height in a range of from about 0.5 μm to about 2.0 μm.

14. The liquid crystal display device of claim 12, wherein the protrusion is disposed on edges of at least two of the plurality of unit sub-pixel electrodes.

15. The curved liquid crystal display device of claim 12, wherein the plurality of unit sub-pixel electrode comprises a cross-shaped stem portion, and branch portions extending from the cross-shaped stem portion in upper-right, lower-right, upper-left, and lower-left directions, respectively.

16. The liquid crystal display device of claim 15, wherein the connecting portion extends from the cross-shaped stem portion.

17. The liquid crystal display device of claim 15, wherein the connecting portion extends from at least one of the branch portions.

18. The liquid crystal display device of claim 17, wherein the protrusion has a cross shape.

19. The liquid crystal display device of claim 12, wherein each of the plurality of unit sub-pixel electrodes comprises a planar portion having a diamond shape, and branch portions extending from the planar portion in upper-right, lower-right, upper-left, and lower-left directions, respectively.

20. The liquid crystal display device of claim 19, wherein the connecting portion extends from the planar portion.
